(19) United States
(12) Patent Application Publication
(10) Pub. No.: US 2009/0324022 A1
(43) Pub. Date: Dec. 31, 2009

(54) Method and Apparatus for Tagging Images and Providing Notifications When Images are Tagged

(75) Inventors: Troed Nils Rickard Sangberg, Malmo (SE); Gert Magnus Jendbro, Staffanstorp (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/145,568

(22) Filed: Jun. 25, 2008

(51) Int. Cl. G06K 9/00; H04Q 7/20; H04N 5/228

(52) U.S. Cl. 382/118; 455/466; 348/222.1; 348/E05.031

(57) ABSTRACT

An image tagging and notification system provides notifications to a user when an image is tagged with personal information of the user. The image tagging and notification system comprises a tag generator to generate tags using facial recognition techniques and a notification unit to generate and send a notification to a user when a image is tagged with the personal information of the user.

### BACKGROUND

The present invention relates generally to a method and apparatus for preserving privacy in a digital world and, more particularly, to a method and apparatus for providing notifications to users when images posted to public Internet sites are tagged with personal information of a person.

The Internet provides users with the ability to search and mine vast amounts of information stored in computers all over the world. The information that is accessible using search engines includes personal information. The popularity of the Internet and the prevalence of digital photography thus raise significant privacy concerns. More and more people are uploading images including photographs and videos to social-networking websites such as FACEBOOK and MYSPACE, and image-hosting websites such as FLICKR and SHUTTERFLY. Users can add descriptive tags to photographs and videos published on the Internet. The addition of tags to published photographs and videos makes them fully searchable using Internet search engines and globally accessible to anyone with an Internet connection.

Even more alarming, new facial recognition systems such as Polar Rose and Riya are making it possible for computers to automatically identify persons in photographs published on the Internet and to tag photos with the names of persons. Both Polar Rose and Riya search the web for photographs and create tags for new photographs by matching faces in the newly-found photographs with previously-tagged photographs. Thus, it is now possible to tag photographs with the names of people with minimal human intervention. Large searchable databases can be generated using facial recognition technology such as Polar Rose and Riya.

In view of the ease with which formerly anonymous photographs can be tagged with the names of persons depicted in the photographs, there is a need for technology to help people maintain some degree of privacy.

### SUMMARY

The present invention provides a method and apparatus for tagging images and providing notifications to users when images are tagged with personal information of the user. The user may then take corrective action as needed to maintain the user's privacy. In one exemplary embodiment, the image tagging and notification system comprises a tag generator and a notification unit. The tag generator compares an image with facial recognition data associated with personal information of a user and generates an image tag from the personal information if the image matches the facial recognition data. The notification unit sends a notification to the user if a image tag is created with the personal information of the user.

The image tagging and notification system may be combined with an image capture device, such as a camera or video recorder. Tags generated can be displayed to the user on the viewfinder of the image capture device.

Exemplary embodiments of the invention comprise method for providing notifications to a user when an image is tagged. An exemplary method comprises comparing an image with facial recognition data associated with personal information of a user, generating an image tag from the personal information if the image matches the facial recognition data, and sending a notification message to the user to inform the user that an image has been tagged with the user's personal information.

In some exemplary methods, the personal information comprises at least one of the user's name, a user identifier used by the user, the user's address, the user's telephone number, and the user's email address.

In some exemplary methods, sending a notification to a user comprises sending at least one of an email notification, an SMS notification, and a voice notification.

In some exemplary methods, sending the notification to a user comprises compiling multiple notifications into a single composite notification and sending the composite notification.

Some exemplary methods further comprise modifying the image to include the image tag and displaying the image with the image tag on a display.

Some exemplary methods further comprise saving the image tag with the image in memory.

In some exemplary methods, the notification is sent in real time before the image is saved.

Exemplary embodiments of the invention may also comprise an image tagging and notification system for providing notifications to a user when an image is tagged. One exemplary image tagging and notifications system comprises a tag generator to compare an image with facial recognition data associated with personal information of a user and to generate an image tag from the personal information if the image matches the facial recognition data, and a notification unit to send a notification to the user if a image tag is created with the personal information of the user.

In some exemplary embodiments of the image tagging and notification system, the personal information comprises at least one of the user's name, a user identifier used by the user, the user's address, the user's telephone number, and the user's email address.

In some exemplary embodiments of the image tagging and notification system, the notification unit sends at least one of an email notification, an SMS notification, and a voice notification.

In some exemplary embodiments of the image tagging and notification system, notification unit compiles multiple notifications into a single composite notification and sends the composite notification.

Some exemplary embodiments of the image tagging and notification system further comprise an image editing processor to modify the image to include the image tag.

Some exemplary embodiments of the image tagging and notification system further comprise a display to display the image with the image tag.

Some exemplary embodiments of the image tagging and notification system further comprise memory to store the image tag with the image.

In some exemplary embodiments of the image tagging and notification system, notification unit sends a notification before the image is saved in memory.

Exemplary embodiments of the invention may also comprise an image capture system. One exemplary image capture system comprises an image capture device to create a digital image, a tag generator to compare the digital image with facial recognition data associated with personal information of a user and to generate an image tag from the personal information if the digital image matches the facial recognition data, and a notification unit to send a notification to the user if an image tag is created with the personal information of the user.

In some exemplary embodiments, the image capture system further comprises an image editing processor to modify the digital image to include the image tag and a display to display the digital image with the image tag.

In some exemplary embodiments, the image capture system further comprises memory to store the image tag with the digital image.

In some exemplary embodiments of the image capture system, the notification unit is configured to send a notification before the digital image is saved in memory.

In some exemplary embodiments of the image capture system, at least one of the tag generator and the notification unit are located in a network server.

In some exemplary embodiments of the image capture system, the tag generator and notification unit are integrated with the image capture device.

In some exemplary embodiments of the image capture system, the tag generator and notification unit are remote from the image capture device.

### BRIEF DESCRIPTION OF THE DRAWINGS

FIG. 1 illustrates an exemplary image tagging and notification system according to one embodiment of the invention for providing notifications to user when images are tagged with the personal information of a user.

FIG. 2 illustrates an exemplary method for tagging images and providing notifications to users according to one embodiment of the invention.

FIG. 3 illustrates an image tagging and notification system combined with an image capture device.

FIG. 4 illustrates a image on a display with image tags.

FIG. 5 illustrates an exemplary method performed by an image capture device.

FIG. 6 illustrates a mobile terminal incorporating an image tagging and notification system.

FIG. 7 illustrates an exemplary embodiment of the image tagging and notification system located in a network server.

### DETAILED DESCRIPTION

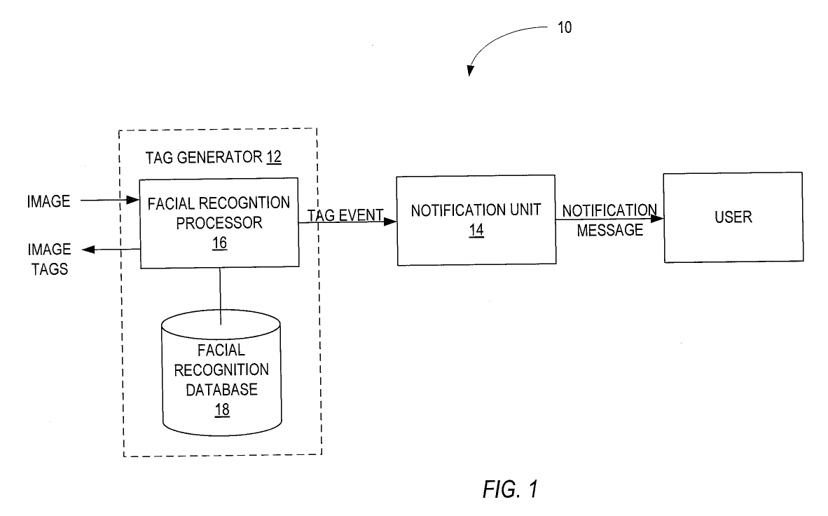

Referring now to the drawings, FIG. 1 illustrates an exemplary image tagging and notification system indicated generally by the numeral 10 for automatically generating image tags and sending notifications to a “user” when an image is tagged with personal information associated with the user. The term user refers to individuals or other legally recognized entities receiving notifications from the image tagging and notification system 10. The image tagging and notification system 10 comprises a tag generator 12 and a notification unit 14. The tag generator 12 generates tags for images using facial recognition techniques. If the face in an image is recognized, a tag is generated and associated with the image. When a tag is generated, the notification unit 14 sends a notification message to the individual depicted in the image.

In one exemplary embodiment, the tag generator 12 comprises a facial recognition processor 16 for extracting faces from images and comparing the extracted faces with facial recognition data stored in a facial recognition database 18. The facial recognition data stored in the facial recognition database is associated with personal information of users, such as the user's name or other identifying information that is used to automatically generate tags for images. The personal information may also include a user identifier adopted by the user (e.g., the user's GMAIL username), the user's home or business address, the user's telephone number. The facial recognition database 18 may also include one or more addresses (email address, telephone number, etc.) for sending notifications to the user. The facial recognition data may be submitted by the users, or may be machine-generated from previously tagged images of the users.

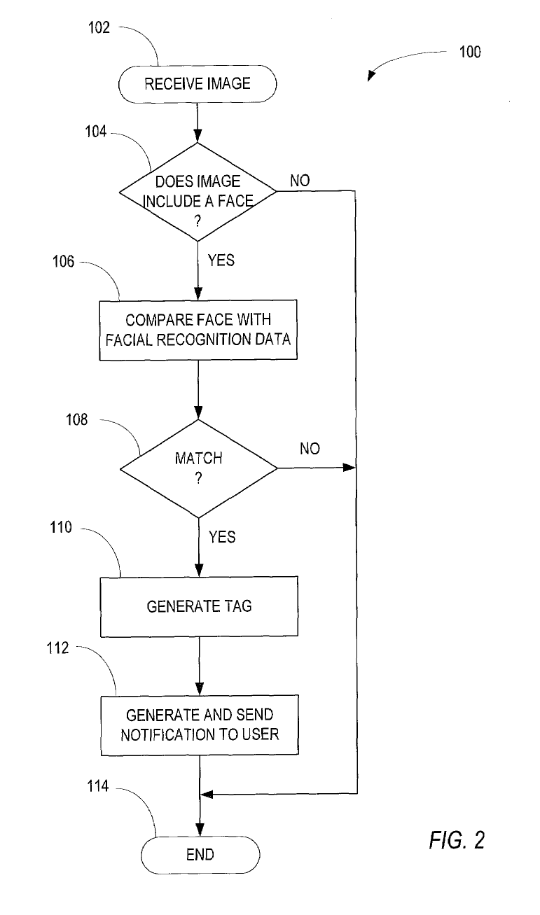

Individuals or other Internet services may submit image data to the image tagging and notification system 10 to automatically generate tags for images. FIG. 2 illustrates an exemplary method 100 implemented by the image tagging and notification system 10 according to one embodiment of the invention. The method begins when the tag generator 12 receives an image (block 102). Upon receipt of an image, the facial recognition processor 16 determines whether the submitted image includes a face (block 104). If not, the method ends (block 114). However, if the image includes at least one face, the facial recognition processor 16 extracts the face from the image and compares the extracted face with facial recognition data stored in the facial recognition database 18 (block 106). If the image depicts multiple persons, the process of extracting and comparing may be performed for each face that is identified by the facial recognition processor 16.

If one of the faces extracted from the image matches facial recognition data stored in the facial recognition database 18 (block 108), the personal information associated with the matching facial recognition data is accessed and used to create a tag for the image (block 110). For example, a name or alias of the user may be retrieved from the facial recognition data and used as a tag for the image. Of course, other personal information associated with the user could also be used as an image tag in place of or in addition to the user's name. For example, the tag may include an address of the user, a telephone number of the user, a username (e.g., FACEBOOK username) for the user, etc.

When a tag for an image is created, the tag generator 12 sends a tag event to the notification unit 14. The tag event may include, for example, the image tag, a link to the image, and the address of the user. Other information could also be included. In response to the tag event, the notification unit 14 generates and sends a notification message to the user who is identified or referenced by the image tag (block 112). The notification message is addressed to the user and may include a link to the image. The notification message can be sent, for example, as an email message, an instant message, an SMS message, an MMS message, a voice message, or other messaging service. The notification sever 14 my use several delivery methods to deliver the notification. The notifications may be sent individually one at a time. Alternatively, multiple notifications may be compiled and sent as a single composite notification. The process ends after the notification message is sent to the user (block 114).

The tag generator 12 and notification unit 14 may be implemented using one or more computers or processors. Separate computers or processors may be used to implement the tag generator 12 and notification unit 14, respectively. Alternatively, the image tag generator 12 and notification unit 14 may be implemented using the same computer or processor. Further, those skilled in the art will appreciate that the computer or processor implementing the tag generator 12 and/or notification server 14 may also perform other tasks.

The tag generator 12 may be co-located with notification sever 14 or at a remote site. For example, the tag generator 12 and notification server 14 may reside on the same host computer, or on different computers on the same local area network (LAN). Alternatively, the tag generator 12 may be accessible over a wide area network (WAN). The WAN may be a public network, such as the Internet, or a private network.

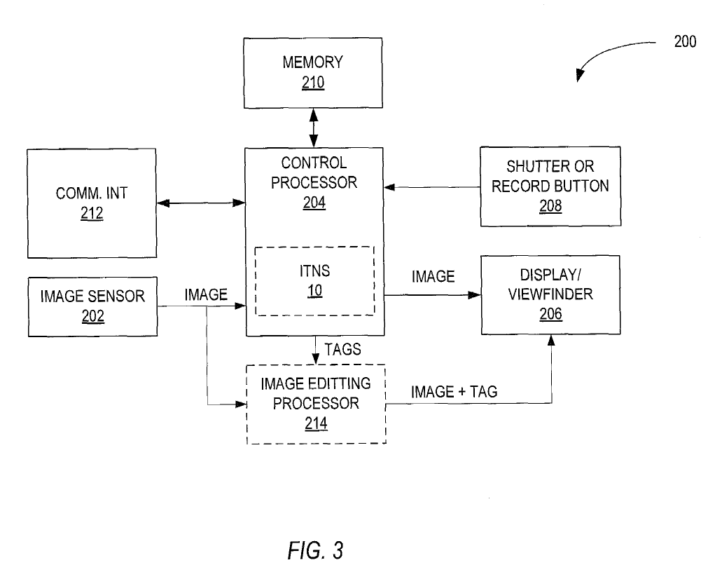

FIG. 3 illustrates an image capture device or system 200, such as a camera or video recorder that operates in conjunction with an image tagging and notification system 10. The image capture device 200 comprises an image sensor 202 for capturing images and converting the captured images into digital images, a control unit 204 to control operation of the image capture device 200, a display/viewfinder 206 to display the images, one or more user controls including a shutter button or record button 208, memory 210 for storing programs and data needed by the control unit 204, and a communication interface 212 for communicating with the image tagging and notification system 10. Alternatively, the image capture and notification system 10 could be incorporated into the image capture device 200. The image sensor 202 may, for example, comprise a charge-coupled device (CCD) or complementary metal-oxide-semiconductor (CMOS) sensor. The control unit 204, which may comprise one or more processors, controls the operation of the image capture device according to programs and instructions stored in memory 208. The images captured by the image sensor 202 are sent via the communication interface 212 to the image tagging and notification system 10, which generates image tags and sends notifications as previously described. The generated image tags are sent back to the image capture device 200. In some embodiments, the image tagging and notification system may be incorporated with the control unit 204 as shown in dotted lines in FIG. 2. The captured images can then be output to the display/viewfinder 206 and/or saved in memory 210 if the user presses the record or shutter button 208. The image format for saved images is preferably one that allows tags to be stored as metadata along with the image. For example, the images and associated tags may be stored in the EXIF format.

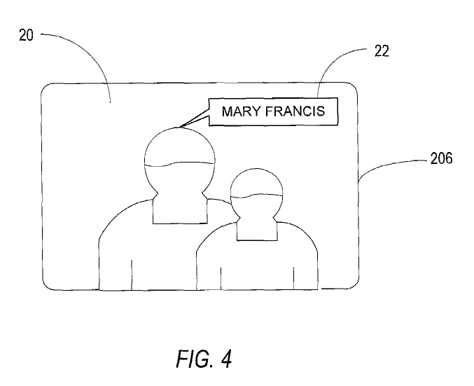

Some embodiments of the image capture device 200 may further include an image editing processor 214, which is shown in dotted lines. The captured images along with any tags generated by the image tagging and notification system 10 may be sent to the image editing processor 214 before the image is displayed on the display 206. The image editing processor 214 may add call-outs to the image including the tag information to identify persons depicted in the image. The image with added call-outs may be sent to the display 206 to identify the persons depicted in the image. FIG. 4 illustrates an exemplary image 20 having image tags added as call-outs 22.

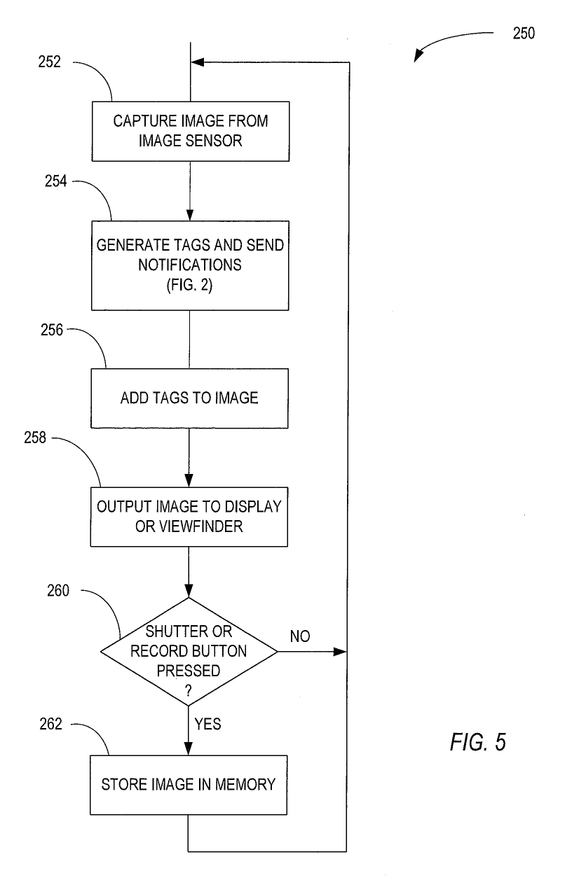

FIG. 5 illustrates an exemplary method 250 implemented by the image capture device 200 according to one embodiment of the invention. The image sensor 202 captures and image and outputs a digital image to the control processor 204 (block 252). The images may comprise either still images or video images. The captured image is supplied to the image tagging and notification system 10, which may be integrated with the image capture device 200 or may be located in a network server accessible to the image capture device 200 via the communication interface 212. The image tagging and notification system 10 generates image tags and sends notifications to persons being depicted as previously described (block 254). It should be noted that the notifications may be sent to the persons being photographed or imaged in real time while the photographer is viewing the person in the display/viewfinder 206 of the image capture device 200. Thus, the person depicted in the image may receive the notification before the image is taken, i.e., before the shutter button or record button 208 is pressed and before the image is recorded and/or saved in memory 210.

The image and any associated tags created may be supplied to the image editing processor 214, if available. If tags are created by the image tagging and notification system 10, the image editing processor 214 adds the generated tags to the image as call-outs (block 256) and outputs the modified image to the display/viewfinder 206 (block 258). The user of the image capture device 200 may then view the image with the added call-out on the display/viewfinder 206 before the shutter button or record button 208 is pressed. If no tags are created, the image editing processor 214 leaves the image unmodified at step 256 and outputs the unmodified image to the display 206 (block 258). When the user presses a shutter button or record button 208 on the image capture device (block 270), the captured image is saved in memory 210 (block 272). If tags have been generated, the tags are stored as metadata along with the image.

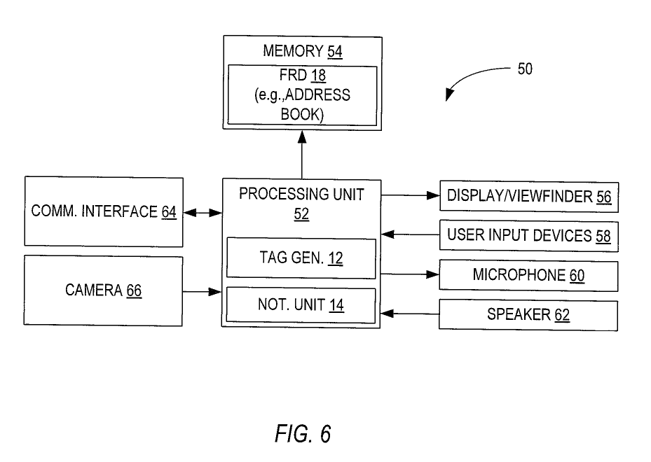

In another exemplary embodiment shown in FIG. 6, the image tagging and notification system 10 is integrated with a mobile terminal 50, such as a personal digital assistant, cellular telephone, or laptop computer. The mobile terminal 50 comprises a processing unit 52, memory 54, display 56, one or more user input devices 58, microphone 60, speakers 62, communication interface 64. The mobile terminal 50 further includes a camera 66 and functions as an image capture device 200.

The processing unit 52 controls the operation of the mobile terminal 50 according to programs and instructions stored in memory 54. Memory 54 stores programs and data used by the processing unit 52 for operation. Memory 54 may also store images taken or recorded with the camera 66.

Display 56 input devices 58, microphone 60, and speaker 62 provide a user interface to enable user interaction with the mobile terminal 50. Display 56 outputs information for viewing by a user and the user input devices 58 receive user input. The display 56 may comprise, for example, a liquid crystal display or touch screen display. The user input devices 58 may comprise a keyboard, keypad, trackball, touch pad, or other type of input device. If a touch screen display is used, the display 56 may also function as a user input device 58. Microphone 60 converts audible sounds into electrical audio signals for input to the processing unit 62, while the speaker 62 converts audio signals output by the processing unit 62 into audible sounds.

The communication interface 64 enables the mobile terminal to communicate over a communication network with other networked devices. The communication interface 64 may comprise, for example, a cellular transceiver (e.g. GSM or WCDMA), a wireless local area network (WLAN) interface (e.g., WiFi), a WiMax interface, Ethernet interface, or other network interface. The camera 66 enables the user to take photographs and/or record video images, which may be stored in memory 54 and/or transmitted via the communication interface 64.

In this exemplary embodiment, the processing unit 52 of the mobile terminal 50 performs the functions of a tag generator 12 and notification server 14. Memory 54 stores an address book that serves as a facial recognition database 18. Facial recognition data is associated with or otherwise linked to entries in the address book. When a user takes a photograph or records video images using the built-in camera 66, the processing unit 52 compares faces of persons in the captured images against the facial recognition data for entries in the address book and generates image tags in real-time for the images when a face being captured in a photograph or video matches an entry in the address book. Thus, a person being photographed can receive notice contemporaneously when their image is being taken.

Images captured by the camera 66 may be output to the display 56 of the mobile terminal 50. The displayed image can be processed in real time to generate image tags as described above, which can then be displayed as call-outs on the displayed image to identify a person in the image being taken to the user of the mobile terminal 50. When the face of a person depicted in an image matches an entry in the address book of the mobile terminal user, the image from the camera 66 is processed to add call-outs to the image. The modified image with call-outs is then sent to the display.

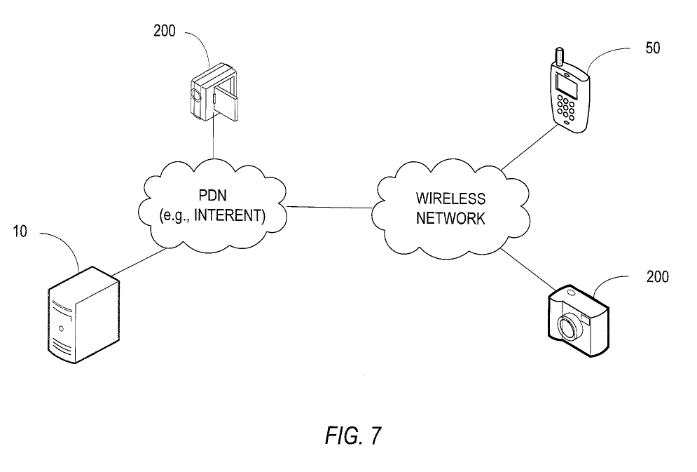

FIG. 7 illustrates an embodiment where the image tagging and notification system 10 is located in a network server. The image tagging and notification system 10 connects to a packet data network (PDN) 150, such as the Internet. Mobile devices, such as mobile terminal 50 and image capture device 200 may also connect to the PDN 150. Alternatively, the mobile terminal 50 and image capture device 200 may get access to the PDN 150 through a wireless network 160.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method for providing notifications to a user when an image is tagged, said method comprising:
comparing a digital image with facial recognition data associated with personal information of a user;
generating an image tag from said personal information if said digital image matches the facial recognition data;
sending a notification message to said user to inform said user that an image has been tagged with the user's personal information.

2. The method of claim 1 wherein said personal information comprises at least one of the user's name, a user identifier used by the user, the user's address, the user's telephone number, and the user's email address.

3. The method of claim 1 wherein sending said notification to said user comprises sending at least one of an email notification, an SMS notification, and a voice notification.

4. The method of claim 1 wherein sending said notification to said user comprises compiling multiple notifications into a single composite notification and sending the composite notification.

5. The method of claim 1 further comprising modifying said digital image to include said image tag and displaying said image with said image tag on a display.

6. The method of claim 1 further comprising saving said image tag with said digital image in memory.

7. The method of claim 1 wherein said notification is sent in real time before the digital image is saved.

8. An image tagging and notification system for providing notifications to a user when an image is tagged, said notification system comprising:
a tag generator to compare an image with facial recognition data associated with personal information of a user, and to generate an image tag from said personal information if said image matches the facial recognition data; and
a notification unit to send a notification to said user if a image tag is created with the personal information of the user.

9. The image tagging and notification system of claim 8 wherein said personal information comprises at least one of the user's name, a user identifier used by the user, the user's address, the user's telephone number, and the user's email address.

10. The image tagging and notification system of claim 8 wherein the notification unit sends at least one of an email notification, an SMS notification, and a voice notification.

11. The image tagging and notification system of claim 8 wherein the notification unit compiles multiple notifications into a single composite notification and sends the composite notification.

12. The image tagging and notification system of claim 8 further comprising an image editing processor to modify said image to include said image tag.

13. The image tagging and notification system of claim 12 further comprising a display to display said image with said image tag.

14. The image tagging and notification system of claim 8 further comprising memory to store said image tag with said image.

15. An image capture system comprising:
an image capture device to create a digital image;
a tag generator to compare said digital image with facial recognition data associated with personal information of a user, and to generate an image tag from said personal information if said digital image matches the facial recognition data; and
a notification unit to send a notification to said user if a image tag is created with the personal information of the user.

16. The image capture system of claim 15 further comprising an image editing processor to modify said digital image to include said image tag and a display to display said image with said image tag.

17. The image capture system of claim 15 further comprising memory to store said image tag with said digital image.

18. The image capture system of claim 15 wherein said at least one of said tag generator and said notification unit are located in a network server.

19. The image capture system of claim 15 wherein the tag generator and notification unit are integrated with the image capture device.

20. The image capture system of claim 15 wherein said tag generator and notification unit are remote from said image capture device.
